(19) United States
(12) Patent Application Publication
(10) Pub. No.: US 2016/0237976 A1
(43) Pub. Date: Aug. 18, 2016

(54) MOTOR VEHICLE AND METHOD FOR ASSEMBLING A MOTOR VEHICLE

(71) Applicant: AUDI AG, 85045 Ingolstadt (DE)

(72) Inventor: MATTHIAS BRENDEL, Ingolstadt (DE)

(73) Assignee: AUDI AG, 85045 Ingolstadt (DE)

(21) Appl. No.: 15/031,462

(22) PCT Filed: Oct. 22, 2014
(86) PCT No.: PCT/EP2014/002851

§ 371 Date: Apr. 22, 2016

(30) Foreign Application Priority Data
Oct. 25, 2013 (DE) 10 2013 017 784.7

(51) Int. Cl. F02N 15/08; F02N 11/00; F16C 3/28; F02N 15/00

(52) U.S. Cl. CPC F02N 15/08; F02N 15/006; F02N 11/00; F16C 3/28; B60K 5/02

(57) ABSTRACT

A motor vehicle with an internal combustion engine which is installed into a motor chamber in the longitudinal direction and which has a multi-joint crank drive with an eccentric shaft and a crankshaft starter is disclosed. The crankshaft starter is arranged relative to the internal combustion engine such that a longitudinal central cylinder plane, which is spanned by longitudinal central cylinder axes of the internal combustion engine, lies between the crankshaft starter and the eccentric shaft.

The invention relates to a motor vehicle with an internal combustion engine mounted in longitudinal direction into a motor compartment, which internal combustion engine has a multi-joint crank drive with an eccentric shaft and a crankshaft starter. The invention also relates to a method for assembling a motor vehicle.

The motor vehicle includes the motor compartment in which the internal combustion engine is arranged. The internal combustion engine is oriented in longitudinal direction. This means that its cylinders or pistons and a crankshaft of the internal combustion engine are arranged substantially in the main driving direction of the motor vehicle. In contrast in the state of the art an arrangement of the internal combustion engine in transverse direction is also known. In this arrangement the cylinders or pistons are correspondingly oriented substantially transverse to the main driving direction or the longitudinal direction of the motor vehicle, i.e., in particular parallel to one or more axles of the motor vehicle.

In the present context however involves the longitudinal arrangement of the internal combustion engine in the motor compartment. Of course deviations from the longitudinal direction are permitted hereby within a certain range for example a deviation of at most 1°, at most 2°, at most 3°, at most 4°, at most 5° or at most 10°. The internal combustion engine has the multi-joint crank drive and the crankshaft starter. The crankshaft starter has the eccentric shaft. The motor vehicle is for example equipped with a front axle or multiple axles, in particular a driven front axle and a driven rear axle, which are driven by the internal combustion engine.

From the state of the art for example the reference U.S. Pat. No. 8,404,171 B2 is known which discloses an internal combustion engine arranged in transverse direction in a motor compartment.

It is an object of the invention to propose a motor vehicle in which an ideal use of space of the motor space and/or a simple mounting of the internal combustion engine is realized.

According to the invention this is achieved with a motor vehicle with the features of claim 1. Hereby it is provided that the crankshaft starter is arranged relative to the internal combustion engine so that a cylinder longitudinal center plane spanned by cylinder longitudinal axes of the internal combustion engine lies between the crankshaft starter and the eccentric shaft. In other words the eccentric shaft is arranged on a first side of the cylinder longitudinal center plane and the crankshaft starter is arranged on a second side of the cylinder longitudinal center plane, wherein the second side is opposite the first side. The cylinder longitudinal center plane is defined by multiple cylinder longitudinal center axes of the internal combustion engine, in particular all cylinder longitudinal center axes of the internal combustion engine. The term cylinder longitudinal center axes means the longitudinal center axes of the cylinder of the internal combustion engine. Each cylinder longitudinal center axis thus defines a center point of the cylinder assigned to it over the longitudinal extent of the cylinder. The cylinder longitudinal center axes extend parallel to each other, in particular the distances between directly adjacent cylinder longitudinal center axes are the same for all cylinders. The cylinder longitudinal center plane incorporates all these cylinder longitudinal center axes; the cylinder longitudinal center axes thus lie in the cylinder longitudinal center plane.

In order to realize a particularly compact configuration of the internal combustion engine, the crankshaft starter and the eccentric shaft are arranged on opposing sides of the cylinder longitudinal center plane. This means that at least one rotation axis of the crankshaft starter and a rotation axis of the eccentric shaft are arranged opposite each other. Particularly preferably, however, the entire crankshaft starter is arranged on the first side of the cylinder longitudinal center plane and the eccentric shaft is arranged on the second side of the cylinder longitudinal center plane. Hereby the term crankshaft starter preferably means an electric machine assigned to the crankshaft starter.

The term crankshaft starter is a starter or starter generator of the internal combustion engine, which engages directly on the crankshaft of the internal combustion engine or is operatively connected with the internal combustion engine via a positive engagement transmission. The positive engagement transmission is for example a gear drive or the like. The crankshaft starter can be permanently operatively connected with the crankshaft of the internal combustion engine. Alternatively only a temporal operative connection is realized. The crankshaft starter is distinguishable from a belt starter, which is operatively connected with the crankshaft via a belt drive. The crankshaft starter is thus explicitly not connected to the crankshaft via such a belt drive.

As mentioned above the crankshaft starter can be realized as a pure starter or as an electric motor or alternatively as a starter generator. With the starter generator also a generator operation can be realized beside a drag of the internal combustion engine in particular for its startup, in which generator operation the kinetic energy of the crankshaft is converted into electric energy, in particular when operating the motor vehicle in a recuperation mode.

As mentioned above, the eccentric shaft is a component of the multi-joint crank drive. The latter has preferably a plurality of coupling elements which are supported rotatably on crankpins of the crankshaft and a plurality of connecting rods which are rotatably supported on crankpins of the eccentric shaft, wherein each of the coupling elements is pivotally connected with a piston rod of the piston of the internal combustion engine and one of the connecting rods. For example the rotation angle of the eccentric shaft can be adjusted by means of a control device in particular in dependence on an operating point of the internal combustion engine.

The multi-joint crank drive in particular has a number of coupling elements which corresponds to the number of pistons of the internal combustion engine and which are each rotatably supported on the corresponding crankpins of the crankshaft and have two arms which protrude over opposite sides of the crankshaft and have a pivot joint. One of the pivot joints serves for pivotal connection with the piston rod, which connects one of the pistons of the internal combustion engine with the crankshaft via the coupling element. Another one of the pivot joints serves for pivotal connection with the so-called connecting rod, which is rotatably supported with its other end on the crankpins of the eccentric shaft.

By means of the multi-joint crank drive the compression ratio in the cylinder, which is assigned to the respective piston, can be adjusted in particular in dependence on the operating point of the internal combustion engine and/or the operating cycle.

For adjusting the compression ratio the eccentric shaft is brought into a defined rotary position which corresponds to the desired compression ratio, or the phase position between the eccentric shaft and the crankshaft is adjusted to a defined value in particular with the aid of the actuator.

A further embodiment of the invention provides that the crankshaft starter is configured as a pinion starter. The pinion starter is characterized in particular in that the crankshaft starter is or can be operatively connected with the crankshaft of the internal combustion engine via a gearwheel transmission. In the first case the pinion starter is permanently operatively connected with the crankshaft via a gearwheel transmission. When only a temporal operative connection between the crankshaft starter or the pinion starter and the crankshaft is intended the pinion starter can have a starter pinion which can be axially displaced on a starter shaft of the pinion starter, which however is operatively connected with the starter shaft in rotative fixed relationship with the starter shaft. In at least one axial position of the starter pinion the starter pinion interacts with a pinion which is permanently operatively connected with the crankshaft in order to establish the operative connection between the pinion starter and the crankshaft. For example the pinion starter is constructed a pre-engaged drive starter.

A particularly preferred embodiment of the invention provides that the internal combustion engine additionally has a belt starter. As mentioned above in contrast to the crankshaft starter the belt starter is operatively connected with the crankshaft via a belt drive. Also the belt starter can be a pure starter or can alternatively be a starter generator, i.e., a belt starter generator.

An embodiment of the invention provides that the belt starter is arranged on the same side of the cylinder longitudinal center plane as the eccentric shaft. Analogous to the arrangement of the crankshaft starter and the eccentric shaft such an arrangement may also be only provided for one rotation axis of the belt starter, so that only this rotation axis but not the entire belt starter is present on the corresponding side of the cylinder longitudinal center axis. Particularly preferably, however, the entire belt starter or an electric machine assigned to the belt starter is provided on the same side of the cylinder longitudinal center plane as the eccentric shaft. This arrangement has the advantage that a greatest possible mounting space for further elements of the internal combustion engine or further aggregates arranged in the motor compartment is available.

A particularly preferred embodiment of the invention provides that the crankshaft starter and/or the belt starter are situated above a parallel plane, which extends parallel to a bottom delimiting plane of the internal combustion engine and receives a rotation axis of the eccentric shaft or which extends parallel to the bottom delimiting plane and tangentially contacts an effective sheath surface of a crankshaft of the internal combustion engine. The bottom delimiting plane is an imaginary plane which is for example defined by the two or three lowest points of the internal combustion engine, in particular of a crankshaft housing of the internal combustion engine. The two points or the three points are hereby particularly preferably selected in a cross section—relative to the rotation axis of the crankshaft of the internal combustion engine. The parallel plane is arranged parallel to this bottom delimiting plane. At the same time it includes the rotation axis of the eccentric shaft so that the eccentric shaft lies in the parallel plane.

As an alternative the parallel plane can be arranged identical with regard to the bottom delimiting plane according to the description above, while however contacting the effective enveloping surface of the crankshaft as tangential plane. The crankshaft hereby in particular includes counter weights, which—in relation to the rotation axis of the crankshaft—are arranged on the side of the crankshaft, which is opposite the crankpins and are hereby arranged rigid on the crankshaft, i.e., co-rotate with the crankshaft during operation of the internal combustion engine. The term effective enveloping surface means the enveloping surface, which results from a complete rotation of the crankshaft. In particular the tangential contact on the enveloping surface is provided on the side of the enveloping surface, which faces the bottom delimiting plane. Of course the tangential contact can however also be realized on the side of the enveloping surface which faces away from the bottom delimiting plane.

It is provided that at least regions of the crankshaft starter and/or the belt starter are arranged above this parallel plane, wherein at least the rotation axis of the crankshaft starter or the belt starter is arranged above the parallel plane. Particularly preferably, however, the entire crankshaft starter and/or the entire belt starter or the corresponding electric machine are provided above the parallel plane. In particular the crankshaft starter is situated closer to the parallel plane than the belt starter. Particularly preferably the crankshaft starter or at least its rotation axis is arranged between the parallel plane and a further parallel plane, which also extends parallel to the bottom delimiting plane of the internal combustion engine, which however includes the rotation axis of the crankshaft. Particularly preferably also the belt starter or at least its rotation axis is situated above this further parallel plane.

A further preferred embodiment of the invention provides that an actuator for adjustment of the eccentric shaft is situated below the parallel plane and/or on the same side of the cylinder longitudinal center plane as the eccentric shaft. As mentioned above the actuator serves for adjusting the eccentric shaft, in particular for adjusting a defined rotary angle and/or a defined phase position of the eccentric shaft and the crankshaft relative to each other. This actuator or at least a rotation axis of the actuator is arranged in the described manner. Particularly preferably, however, the entire actuator is provided below the parallel plane or on the same side of the cylinder longitudinal center plane as the eccentric shaft. As a result of the low arrangement of the actuator a particularly low center of gravity of the internal combustion engine is achieved. The described arrangement of the actuator is additionally well accessible and unproblematic in terms of thermal considerations.

A preferred embodiment of the invention provides that a transmission, which operatively connects the actuator and the eccentric shaft, is arranged, when viewed in longitudinal direction of the internal combustion engine, on a side of the internal combustion engine which faces away from a crankshaft output. The longitudinal direction of the internal combustion is hereby the direction along the rotation axis of the crankshaft. The crankshaft output is usually arranged on a rear side of the internal combustion engine so that correspondingly the transmission is now arranged on the front side of the internal combustion engine. This avoids conflicts regarding mounting space when connecting the internal combustion engine via the crankshaft output.

Finally it can be provided that the crankshaft starter is arranged in a hollow space provided between the internal combustion engine and a motor support, wherein the internal combustion engine is fastened to a body of the motor vehicle via the motor support. The internal combustion engine is assigned the at least one motor support. Via this motor support the internal combustion engine is essentially fixed in position in the motor compartment of the motor vehicle. The motor support has hereby for example at least two fastening arms via which it engages on the internal combustion engine. Via a coupling arm the fastening arms are connected with the body of the motor vehicle. After fastening the motor support on the internal combustion engine the fastening arms together with the internal combustion engine form the hollow space. In this hollow space at least regions of the crankshaft starter, in particular the entire crankshaft starter, is to be arranged. Due to the arrangement of the crankshaft starter in the hollow space thermal stress on the crankshaft starter as a result of the operation of the internal combustion engine, in particular as a result of the exhaust gas produced by the internal combustion engine, is significantly decreased. In particular the motor support also serves as insulation for the crankshaft starter.

The invention also relates to a method for assembling a motor vehicle, in particular a motor vehicle according to the description above, wherein the motor vehicle has an internal combustion engine which is mounted in a motor compartment in longitudinal direction, an which has a multi-joint crank drive with an eccentric shaft and a crankshaft starter. Hereby it is provided that the crankshaft starter is arranged relative to the internal combustion engine so that a cylinder longitudinal center plane spanned by cylinder longitudinal center axes of the internal combustion engine is situated between the crankshaft starter and the eccentric shaft. The advantages of such an approach or such a configuration of the motor vehicle were already discussed above. The method and the motor vehicle can be further refined according to the discussion above so that reference is made thereto. The terms crankshaft starter, belt starter and actuator preferably mean respectively the electric motor or the respective electric machine which is/are provided in the corresponding device.

Particularly advantageously it can be provided that the crankshaft starter is arranged on the internal combustion engine and is electrically connected with the internal combustion engine, and an exhaust gas system is subsequently connected to the internal combustion engine. It is also provided to first completely mount, in particular fasten, the crankshaft starter on the internal combustion engine, and to establish the electrical contact to the internal combustion engine or the control unit of the internal combustion engine. Only then the exhaust gas system consisting for example of an exhaust manifold and/or at least one exhaust gas duct is arranged and fastened on the internal combustion engine.

Hereby it can also be provided that prior to the fastening of the exhaust gas system on the internal combustion engine the already described motor support is fastened on the internal combustion engine so that the crankshaft starter is received in the hollow space formed between the internal combustion engine and the motor support. Particularly preferably, the entire crankshaft starter and also the electrical lines used for its contacting are completely received in the hollow space so that it is subsequently protected against damage. In the subsequent fastening of the exhaust gas system and/or a mounting of the internal combustion engine in the motor compartment of the motor vehicle, damage to the crankshaft starter is thus prevented.

In the following the invention is explained in more detail by way of the exemplary embodiment shown in the drawing without limiting the invention. Hereby it is shown in:

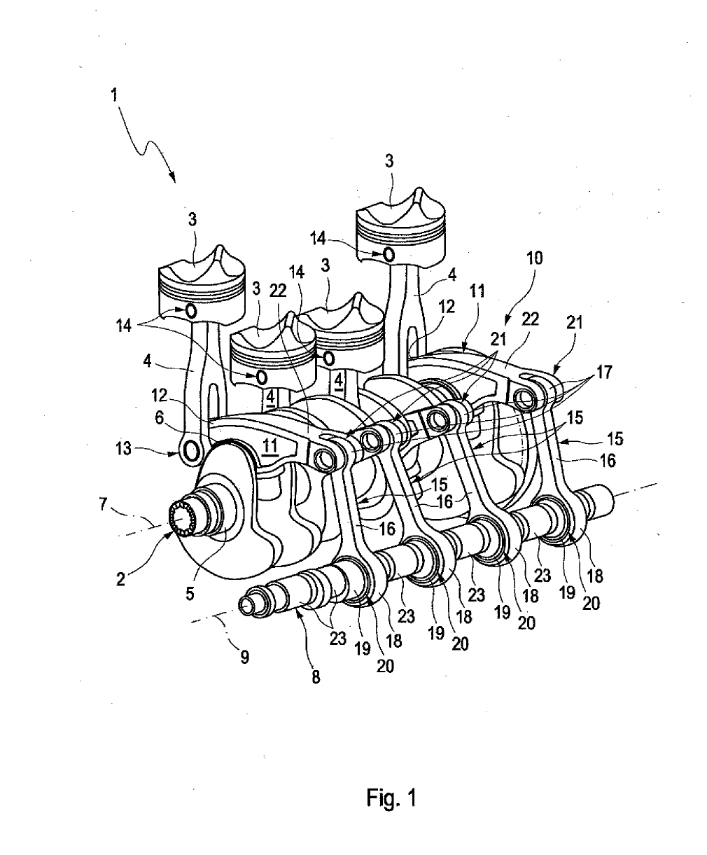

FIG. 1 a perspective view of a region of an internal combustion engine,

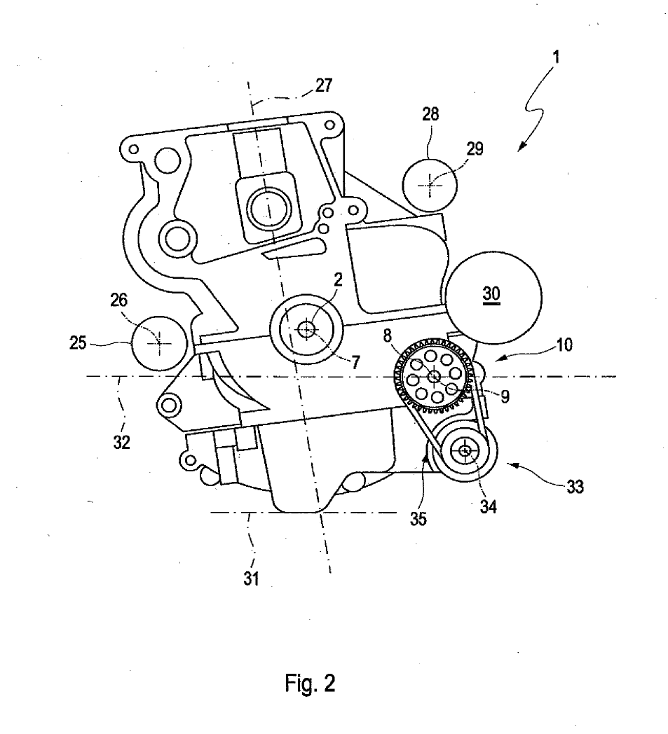

FIG. 2 a front view of the internal combustion engine,

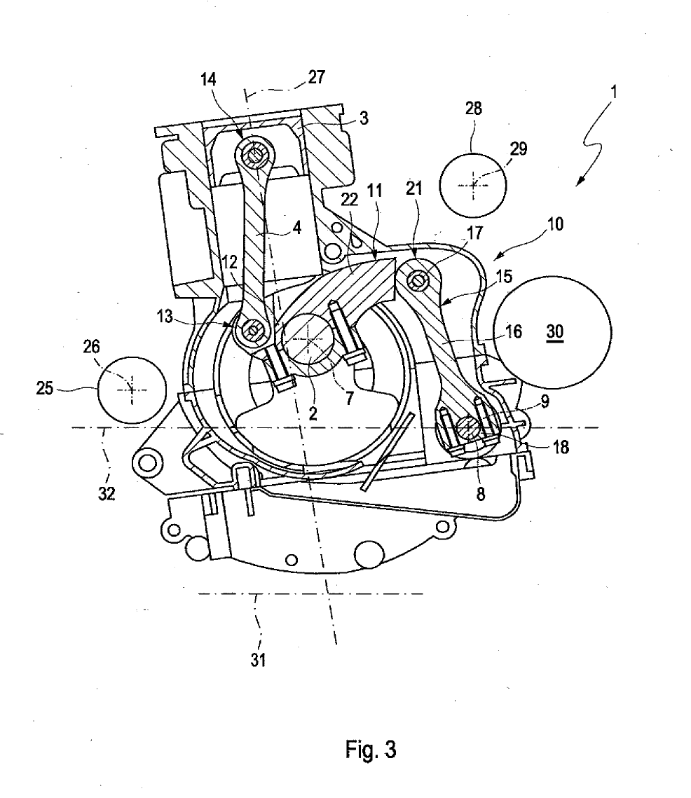

FIG. 3 a front sectional view of the internal combustion engine,

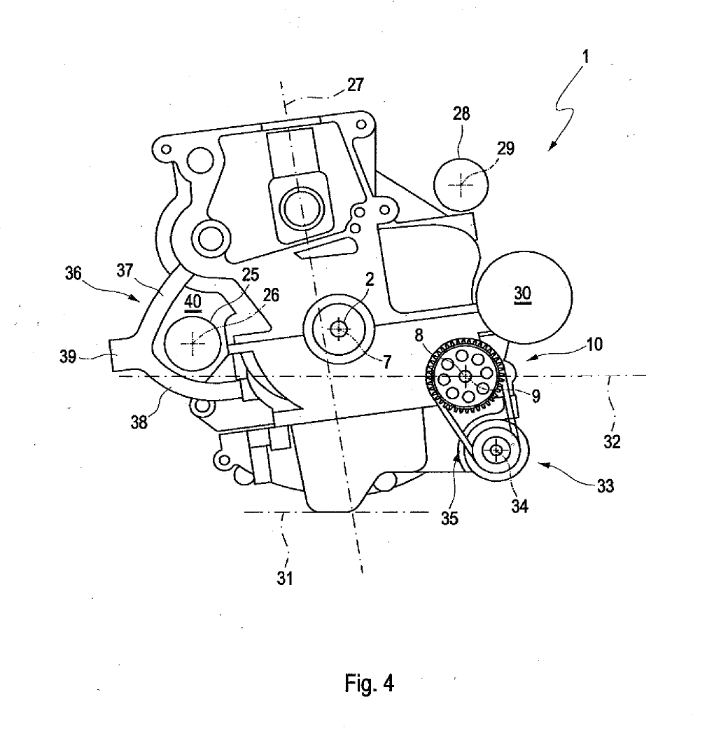

FIG. 4 a front view of the internal combustion engine with a motor support for fastening the internal combustion engine on a body of a motor vehicle and

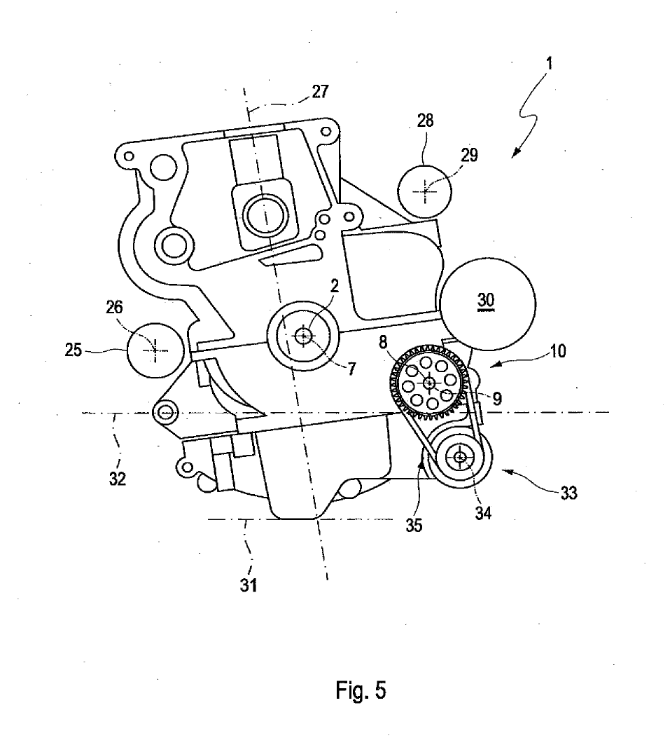

FIG. 5 a front view of the internal combustion engine in an alternative embodiment and

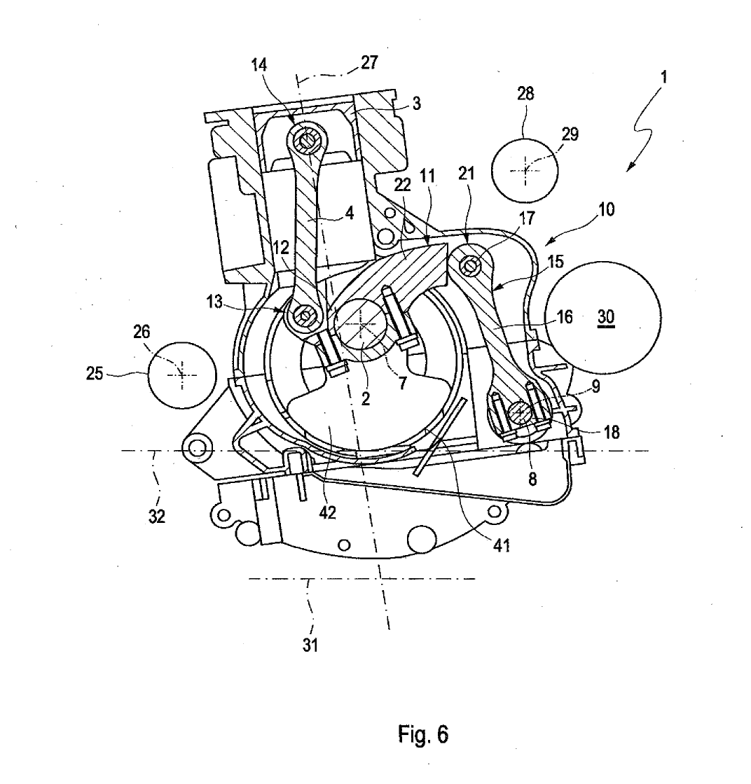

FIG. 6 a front sectional view of the internal combustion engine in the alternative embodiment

FIG. 1 shows a perspective view of a region of an internal combustion engine 1, which is in particular an inline internal combustion engine, for example a four-cycle four-cylinder inline internal combustion engine. The internal combustion engine 1 has a crankshaft 2 and multiple pistons 3 each of which is movably supported in one of multiple not shown cylinders of the internal combustion engine 1. Each of the pistons 3 is connected with the crankshaft 2 by a piston rod 4. The crankshaft 2 is rotatably supported in here not shown shaft supports of an also not shown cylinder crankcase of the internal combustion engine 1 and has at least one central shaft journal 5 serving for support and multiple crankpins 6 (of which in FIG. 1 only one respective one is visible), whose longitudinal center axes are offset parallel to a rotation axis 7 of the crankshaft 2 in different angular orientations.

The internal combustion 1 also includes an eccentric shaft 8, which preferably has a rotation axis 9 that is parallel to the rotation axis 7 of the crankshaft 2. The eccentric shaft 8 is for example rotatably supported in the cylinder crankcase adjacent the crankshaft 2 and slightly below the same and coupled with the crankshaft 2. The eccentric shaft 8 is a component of a multi-joint crank drive 10 which further includes multiple coupling elements 11 which are each rotatably supported on a crankpin 6 of the crankshaft 2. Each of the coupling elements 11 has a lift arm 12, which is pivotally connected with a lower end of one of the piston rods 4 via a pivot joint 13. An upper end of the respective piston rod 4 is articulately connected on the associated piston 3 via a further pivot joint. Overall thus each of the pistons 3 is operatively connected with the crankshaft 2 by the respective piston rod 4 and the respective coupling element 11.

The multi-joint crank drive 10 further includes a number of connecting rods 15, which correspond to the number of the coupling rod 4 and the coupling elements 11. The connecting rods are oriented for example approximately parallel to the piston rod 4 and in axial direction of the crankshaft 2 and the eccentric shaft 8 in each case in about the same plane as the associated piston rod 4, however, on the opposite side of the crankshaft 2. Each connecting rod 15 includes a connecting rod body 16 and two conrod eyes 17 and 18, which are arranged at opposing ends of the connecting rod 16, in particular with different diameters. The greater conrod eyes 18 of each connecting rod 15 at the lower end of the connecting rod body 16 surrounds a crankpin 19 of the eccentric shaft 8, which is eccentric with respect to the rotation axis 9 of the eccentric shaft 8, on which crankpins 19 the connecting rod 15 is rotatabley supported by means of a rotary bearing 20. The smaller conrod eyes 17 at the upper end of the connecting rod 16 of each connecting rod 15 forms a part of a pivot joint 21 between the connecting rod 15 and a longer coupling arm 22 of the neighboring coupling element 11 which protrudes over the crankshaft 2 on the side of the crankshaft 2 which is opposite the lift arm 12.

The eccentric shaft 8 has between neighboring eccentric crankpins 19 and at its front ends coaxial shaft sections 23, which serve for supporting the eccentric shaft 8 in shaft bearings. Aside from a variable compression the arrangement described above also allows reducing the incline of the piston rod 4 relative to the cylinder axis or the cylinder longitudinal center axis of the associated cylinders during the rotation of the crankshaft 2, which leads to a reduction of the piston side forces and with this the frictional forces between the pistons 2 and the cylinder walls of the cylinders.

As an alternative of course also a different embodiment of the internal combustion engine 1 or the multi-joint crank drive 10 can be realized. The described embodiments are exemplary and serve for explaining the general functioning of the individual elements.

FIG. 2 shows a front view of the internal combustion engine 1. The internal combustion engine 2 has a crankshaft starter 25, which is here only shown schematically. A rotation axis 26 of the crankshaft starter 25 of an electric motor of the crankshaft starter 25 is also indicated. The crankshaft starter 25 is arranged so that between the crankshaft starter and the eccentric shaft 8, in particular with respect to the internal combustion engine 1, a cylinder longitudinal center plane 27 is arranged which is defined by multiple cylinder longitudinal center axes of cylinders of the internal combustion engine 1. For example the crankshaft starter 25 is configured as a pinion starter. In addition the internal combustion engine 1 can have a belt starter 28, wherein the belt starter or an electric motor of the belt starter 28 has a rotation axis 29. At least this rotation axis 29, preferably however the entire belt starter 28, is arranged on the same side of the cylinder longitudinal center plane 27 as the eccentric shaft 8. In vertical direction between the belt starter 8 and the eccentric shaft 8 an air conditioning compressor 30 can be provided.

In the here shown embodiment of the internal combustion engine 1, the latter has a bottom delimiting plane 31, which is for example defined by the lowest points, in particular by the three lowest points of the internal combustion engine 1. Situated parallel to the bottom delimiting plane 31 is a parallel plane 32, which is arranged so that it includes the eccentric shaft 8 or its rotation axis. As an alternative the parallel plane 32 can also be defined so that it is spanned by an imaginary straight line, which intersects the rotation axis of the eccentric shaft 8, together with the rotation axis. The straight line is hereby a line which extneds parallel to a further straight line which is defined by the two points which in cross section of the internal combustion engine 1 are positioned the lowest. It can be seen that the crankshaft starter 25 as well as the belt starter 28 are situated above this parallel plane 32. However, it can also be provided that only the crankshaft starter 25 or only the belt starter 28 are arranged above the parallel plane 32.

For adjusting the eccentric shaft 8 an actuator 33 is provided which for example includes an electric motor with a rotation axis 34. This actuator 33 or its electric motor or at least the rotation axis 34 are to be arranged below the parallel plane 32. Particularly preferably, the entire mentioned element is arranged on the same side of the cylinder longitudinal center plane 27 as the eccentric shaft 8. Between the actuator 33 and the eccentric shaft 8 a transmission 35 is provided, which is here realized as a belt transmission. The latter is provided on the front side of the internal combustion engine 1, wherein a here not visible crankshaft output, at which the crankshaft 2 is operatively connected with an output shaft, is situated on the rear side.

FIG. 3 shows a front sectional view of the internal combustion engine 1. The individual components of the multi-joint crank drive 10 can be clearly recognized. For further explanation reference is made to the discussion above.

FIG. 4 again shows the front view of the internal combustion engine 1, wherein a motor support 36 can be recognized, which engages on the internal combustion engine 1. The internal combustion engine 1 is configured according to the description above. The motor support 36 has for example two fastening arms 37 and 38 and a coupling arm 39. The motor support 36 engages with the fastening arms 37 and 38 on the internal combustion engine 1, while the fastening arms 37 and 38 are connected with a body of the motor vehicle via the coupling arm 39 for holding the internal combustion engine 1 in the motor compartment. It can be seen that the fastening arms 37 and 38 form a hollow space 40 together with the internal combustion engine, in which at least regions of the crankshaft starter 25, in particular the entire crankshaft starter, is arranged. Thus the crankshaft starter 25 is protected against damage and/or thermal influences.

FIG. 5 shows a front view of the internal combustion engine 1 in an alternative embodiment. Generally the description above applies. Also the motor support 36 can be additionally provided. The difference to the embodiment described above is only the arrangement of the parallel plane 32. The parallel plane 32 again is situated parallel to the bottom delimiting plane 31, however, it tangentially contacts an effective envelop sheath 41 (here not visible) of the crankshaft 2 of the internal combustion engine 1. Hereby the rotation axis 9 of the eccentric shaft 8, in particular the entire eccentric shaft 8, is arranged above the parallel plane 32. In particular the eccentric shaft 8 is thus arranged on the same side of the parallel plane 32 as the crankshaft starter 25 and/or the belt starter 28 and/or the air conditioning compressor 30 and/or the rotation axis 7 of the crankshaft 2.

FIG. 6 shows a front sectional view of the alternative embodiment of the internal combustion engine 1. It can be seen that the effective envelop surface 41 of the crankshaft 2 is substantially defined by one or more counter weights 42, which are assigned to the crankshaft 2 and co-rotate with the crankshaft during operation of the internal combustion engine 1.

### LIST OF REFERENCE SIGNS

1 internal combustion engine
2 crankshaft
3 piston
4 piston rod
5 shaft journal
6 crankpins
7 rotation axis
8 eccentric shaft 8
9 rotation axis
10 multi-joint crank drive
11 coupling element
12 lift arm
13 pivot joint
14 pivot joint
15 connecting rod
16 connecting rod body
17 conrod eye
18 conrod eye
19 crankpins
20 rotary bearing
21 pivot joint
22 coupling arm
23 shaft section
24 (eccentric shaft transmission)
25 crankshaft starter
26 rotation axis
27 cylinder longitudinal center plane
28 belt starter
29 rotation axis
30 air conditioning compressor
31 bottom delimiting plane
32 parallel plane
33 actuator
34 rotation axis
35 transmission
36 motor support
37 fastening arm
38 fastening arm
39 coupling arm
40 hollow space
41 sheath surface
42 counter weight

What is claimed is:

1.-10. (canceled)

11. A motor vehicle, comprising:
an internal combustion engine mounted in longitudinal direction in a motor space of the motor vehicle, said internal combustion engine comprising a multi-joint crank drive with an eccentric shaft;
a crankshaft starter arranged relative to the internal combustion engine so that a cylinder longitudinal center plane spanned by cylinder longitudinal center axes of the internal combustion engine is situated between the crankshaft starter and the eccentric shaft;
a belt starter arranged on a same side of the cylinder longitudinal center plane as the eccentric shaft, wherein the crankshaft starter and the belt starter are arranged above a parallel plane which extends parallel to a bottom delimiting plane of the internal combustion engine and includes a rotation axis of the eccentric shaft and the belt or which extends parallel to the bottom delimiting plane and tangentially contacts an effective enveloping surface of a crankshaft of the internal combustion engine; and
an actuator for adjusting the eccentric shaft, said actuator being situated below the parallel plane and on the same side of the cylinder longitudinal center plane as the eccentric shaft.

12. The motor vehicle of claim 11, wherein the crankshaft starter is configured as a pinion starter.

13. The motor vehicle of claim 11, further comprising a transmission operatively connecting the actuator and the eccentric shaft, said transmission being arranged when viewed in longitudinal direction of the internal combustion engine on a side of the internal combustion engine which faces away from an output of the crankshaft.

14. The motor vehicle of claim 11, further comprising a motor support, wherein the crankshaft starter is arranged in a hollow space formed between the internal combustion engine and the motor support, and wherein the internal combustion engine is fastened to a body of the motor vehicle via the motor support.

15. A method for assembling a motor vehicle, said method comprising:
mounting an internal combustion engine in the motor vehicle in longitudinal direction in a motor space of the motor vehicle, said internal combustion engine comprising a multi-joint crank drive with an eccentric shaft,
wherein the internal combustion engine is mounted in the vehicle so that
a crankshaft starter is arranged relative to the internal combustion engine so that a cylinder longitudinal center plane spanned by cylinder longitudinal center axes of the internal combustion engine is situated between the crankshaft starter and the eccentric shaft,
a belt starter is arranged on a same side of the cylinder longitudinal center plane as the eccentric shaft, wherein the crankshaft starter and the belt starter are arranged above a parallel plane which extends parallel to a bottom delimiting plane of the internal combustion engine and includes a rotation axis of the eccentric shaft and the belt or which extends parallel to the bottom delimiting plane and tangentially contacts an effective enveloping surface of a crankshaft of the internal combustion engine; and
an actuator for adjusting the eccentric shaft is situated below the parallel plane and on the same side of the cylinder longitudinal center plane as the eccentric shaft.

16. The method of claim 15, further comprising arranging the crankshaft starter of the internal combustion engine on the internal combustion engine and electrically connecting the crankshaft starter to the internal combustion engine, and subsequently fastening an exhaust gas system on the internal combustion engine.
